(19) United States
(12) Patent Application Publication
(10) Pub. No.: US 2007/0098992 A1
(43) Pub. Date: May 3, 2007

(54) Heater unit manufacturing method

(75) Inventors: Teiji Hasegawa, Komae-shi (JP); Shuichi Suemura, Komae-shi (JP)

Correspondence Address: NIXON PEABODY, LLP, 401 9TH STREET, NW, SUITE 900, WASHINGTON, DC, 20004-2128, US

(73) Assignee: Tokyo Technological Labo Co., Ltd., Komae-shi, Tokyo (JP)

(21) Appl. No.: 10/558,288

(22) PCT Filed: Apr. 19, 2004
(86) PCT No.: PCT/JP04/05565

§ 371 Date: Nov. 9, 2006

(30) Foreign Application Priority Data
May 26, 2003 (JP) 2003-147567

(51) Int. Cl. B60R 21/16; B32B 7/02; B32B 9/00

(52) U.S. Cl. 428/408; 428/36.1; 428/218

(57) ABSTRACT

A heater unit manufacturing method constituted by the steps of: forming multitudes of inorganic fibers into a heat insulating housing block through molding; heat treating the heat insulating housing block after impregnating the block with heat resistant resin; and mounting a heating element inside of the heat treated heat insulating housing block.

### TECHNICAL FIELD

The present invention relates to a heater unit manufacturing method. More specifically, the present invention is directed to a method for manufacturing a heater unit to be mounted on the heating object, such as piping and a valve.

### BACKGROUND ART

For a valve mounted, for example, on a piping system that supplies gas to semiconductor manufacturing equipment or the like, it is necessary to prevent formation of dew condensation within the valve due to a temperature drop in the gas as it passes through the valve. In addition, a valve mounted on a piping system that carries liquid, which solidifies at a temperature near room temperature, it is necessary to prevent a blockage of the valve or development of accretion within the valve due to solidification of the liquid. Still further, for a piping system that carries high temperature gas or liquid, a temperature drop in the fluid as it passes through the valve is a problem when the fluid needs to be carried through the piping system without any appreciable temperature drop.

In order to prevent these problems, different types of heating mechanisms, which are built in or attached to a fluid valve, for heating the area within the valve where the fluid passes or the like have been proposed.

A so-called mantle heater type heating mechanism is known as one of such heating mechanisms, in which a heating object, such as piping or a valve is covered by a fiber cloth having a heater built therein. The heater unit described above is produced by stitching a heater (heating element), such as a nichrome wire or the like, on a heat insulating blanket, and covering the outer surface of the blanket with a heat-resistant cloth. By covering the valve or piping connected to the valve with the heat-resistant cloth so produced, and heating it by the built-in heater, it is maintained at a predetermined temperature.

Another type is also known as described, for example, in Japanese Unexamined Patent Publication No. 7(1995)-71648 (FIG. 1), in which a valve itself is constituted by two fitting components, and a heater is disposed between the two components.

Still another open/close valve is also known as described, for example, in Japanese Unexamined Patent Publication No. 2001-349468 (FIG. 3). The valve has a main body which is square in cross-section, and a heater is provided on each of thee lateral faces. A heat transfer body is disposed between each of the heaters and the main body of the valve. In addition, a thermistor is provided adjacent to the heater to heat or maintain the valve at a predetermined temperature.

A fluid control valve having a flapper plate in the flow path is known as another type of heater as described, for example, in PCT Japanese Publication No. 10(1998)-502995 (FIGS. 2 and 4). The flapper plate that opens/closes the flow path is rotatably supported by a supporting shaft, in which a heating means is installed. The heat produced by the heating means is conveyed to the fluid through the supporting shaft and flapper plate.

As for the method for manufacturing heat insulating materials, a method for manufacturing a heat insulating material which is exposed to high temperatures is known as describe, for example, in PCT Japanese Publication No. 2002-523669 (FIG. 2). The heat insulating material described above is, for example, a cloth-like material applied to an injection nozzle of a rocket engine by lining, which is produced by impregnating a carbon cloth with a resin base material. As for the precursors of the carbon cloth, viscose rayon, continuous filament polyacrylonitrile, cellulose filament, and the like are disclosed. As for the resin base materials, phenol resin is disclosed.

The heater units according to conventional technologies are either built in a heating object, for example, in a valve, or applied from outside of the valve or piping. Or else, they are constructed as a cloth-like heater, such as that applied to the inside of a rocket engine by lining. These heaters have, therefore, caused various problems.

For example, the mantle heater type heating mechanism described above has a problem that it often emits dust and the surrounding area of the heating object becomes dusty. In order to cope with the environmental and sanitary problem, the heat resistant cloth is covered with plastic, if the temperature of generated heat is relatively low, or by a metal case, if it is relatively high, to prevent dust emissions. This has, however, resulted in another problem that the structure is complicated, and the heater is costly due to a larger number of parts. Further, it is difficult to cover a heating object in close contact if a heating object has a complicated configuration. This has caused energy loss due to inefficient heat transfer from the heater to the heating object.

Further, in the heater disclosed in Japanese Unexamined Patent Publication No. 7(1995)-71648, the open/close valve is constituted by two main bodies to dispose the heater between them. This may result in larger number of parts and require greater manpower for assembly. In addition, where a valve and piping connected to the valve needs to be heated, additional heaters are required.

In the heater disclosed in Japanese Unexamined Patent Publication No. 2001-349468, the heater unit is provided at a plurality of sections around the valve, resulting in a larger number of parts and complicated structure.

Further, in the heater disclosed in PCT Japanese Publication No. 10(1998)-502995, the heater unit is provided inside of the valve having a specific structure, which may restrict the design of the heater and may not be applicable to any other type of valves, that is, the heating object.

Still further, the heat insulating material disclosed in PCT Japanese Publication No. 2002-523669 may be applied to an object by lining as the material to be exposed to high temperatures. But it may not be used for heating and retaining the temperature of the object together with a heating means without modification.

As described above, conventional technologies have many problems including dust emissions, larger number of parts, complicated structures, increased costs due to complicated structures, and the like. Further, it has been difficult to manufacture a heater unit capable of uniformly heating a heating object having a complicated structure by conventional methods. In particular, it has been difficult to effectively heat and maintain the temperature of the region that includes not only a heating object but also the peripheral region, such as piping connected to a valve.

In view of the circumstances described above, it is an object of the present invention to provide a method for manufacturing a dust emission free and simply structured heater with minimized parts at low cost.

It is another object of the present invention to provide a method for manufacturing a low energy loss heater, which is capable of integrally and uniformly heating a heating object having a complicated structure to maintain the heating object at a high temperature.

### DISCLOSURE OF INVENTION

The heater unit manufacturing method of the present invention is a method comprising the steps of forming multitudes of inorganic fibers into a heat insulating housing block according to the contour of a heating object, heat treating the heat insulating housing block after impregnating the block with heat resistant resin, and mounting a heating element inside of the heat treated heat insulating housing block. Preferably, the heat resistant resin is organic silicon carbide series paint.

As for the inorganic fibers, ceramic fibers are preferable. The ceramic fibers are short length fibers of high purity alumina. In addition to alumina, other elements, such as silica and the like may also be included as the components of the ceramic fibers, and the ratio of the components may be changed accordingly.

Preferably, the heat treating step comprises the steps of a first heat treating step in which the housing block is preliminarily heated at a temperature in the range from 200 to 300 degrees Celsius; and a second heat treating step in which the housing block is ultimately heated at a temperature in the range from 350 to 500 degrees Celsius.

More preferably, the first heat treating step is performed at a temperature in the range from 240 to 260 degrees Celsius, and the second heat treating step is performed at a temperature in the range from 440 to 480 degrees Celsius.

The heater unit manufacturing method of the present invention may further comprises the step of applying heat resistant paint with fine silicon powders mixed therein on the external surface of the heat insulating housing block after the heating element is mounted therein.

Further, an electrical insulating layer for the heating element mounted in the heat insulating housing block may be formed by applying high heat resistant surface hardening agent or the like on the heating element and solidifying the agent.

The heater unit manufacturing method of the present invention comprises the steps of forming multitudes of inorganic fibers into a heat insulating housing block according to the contour of a heating object, heat treating the heat insulating housing block after impregnating the block with heat resistant resin, and mounting a heating element inside of the heat treated heat insulating housing block. Consequently, the method has the following advantageous effects.

That is, according to the heater unit manufacturing method, the heater unit may be formed according to the contour of a heating object. In addition, the external surface of the heater unit is solidified by the impregnation of heat resistant resin and heat treatment, and a heat insulating layer constituted by multitudes of fibers and airspace is formed inside of the heater unit. Consequently, while providing heat insulating properties, the heater unit is free from dust emissions, including fiber dispersal from the surface of the heater unit. Thus, it has no adverse effects on environment and human body. Accordingly, any plastic or metal cover for the heater unit is not required for preventing dust emissions. Further, the heater unit may be formed integrally according to the contour of a heating object, and a heating element is mounted therein. This allows the heater unit to be manufactured at low cost with less number of parts. Still further, the heating element may be disposed adjacent to a heating object of any configuration, which allows energy efficient uniform heating. That is, it is comparatively free to set the region of heating object, and the heater unit may be readily formed such that the heating element is placed in close contact with the heating object, which may enhance the accuracy of the temperature to be maintained.

Further, in the case where organic silicon carbide series paint is used as the heat resistant resin to be impregnated in the heat insulating housing block, a high heat resistant heater unit may be manufactured, which is capable of high temperature heating of approximately 350 degrees Celsius.

Still further, in the case where the heat treating step comprises a first heat treating step in which the housing block is preliminarily heated at a temperature in the range from 200 to 300 degrees Celsius and a second heat treating step in which the housing block is ultimately heated at a temperature in the range from 350 to 500 degrees Celsius, the low temperature solvent (binder) of the impregnated organic silicon carbide series paint is removed in the first heat treating step, and the impregnated material of the organic silicon carbide series paint is ceramitized in the second heat treating step. This prevents foams from being formed on the surface of the housing block due to the binder, and the surface of the heat insulating housing block is strengthened, thereby machining, such as surface grinding and the like, may become possible. This makes the configuration of the housing block to further fit with that of the heating object, allowing more uniform heating.

Further, in the case where the first heat treating is performed at a temperature in the range from 240 to 260 degrees Celsius, and the second heat treating is performed at a temperature in the range from 440 to 480 degrees Celsius, the surface reinforcing layer may be formed more effectively.

Still further, in the case where heat resistant paint with fine silicon powders mixed therein is applied on the external surface of the heat insulating housing block after the heating element is mounted therein, a surface finish of improved smoothness may be obtained.

As has been described, the heater unit manufacturing method of the present invention may be readily applied to a heating object of any configuration, so that heater units for various applications may be manufactured by the method.

### BRIEF DESCRIPTION OF DRAWINGS

FIG. 1 is a flowchart illustrating respective steps of the heater unit manufacturing method of the present invention.

FIG. 2 is an exploded perspective view of an illustrative heater unit manufactured by the heater unit manufacturing method of the present invention.

FIG. 3 is a perspective view of a valve which is an illustrative heating object of the heater unit manufactured by the heater unit manufacturing method of the present invention.

FIG. 4 is a drawing illustrating the valve shown in FIG. 3 with the heater unit shown in FIG. 2 being mounted thereon.

FIG. 5 is a perspective view of a heat insulating housing block for forming a housing half of a heater unit.

### BEST MODE FOR CARRYING OUT THE INVENTION

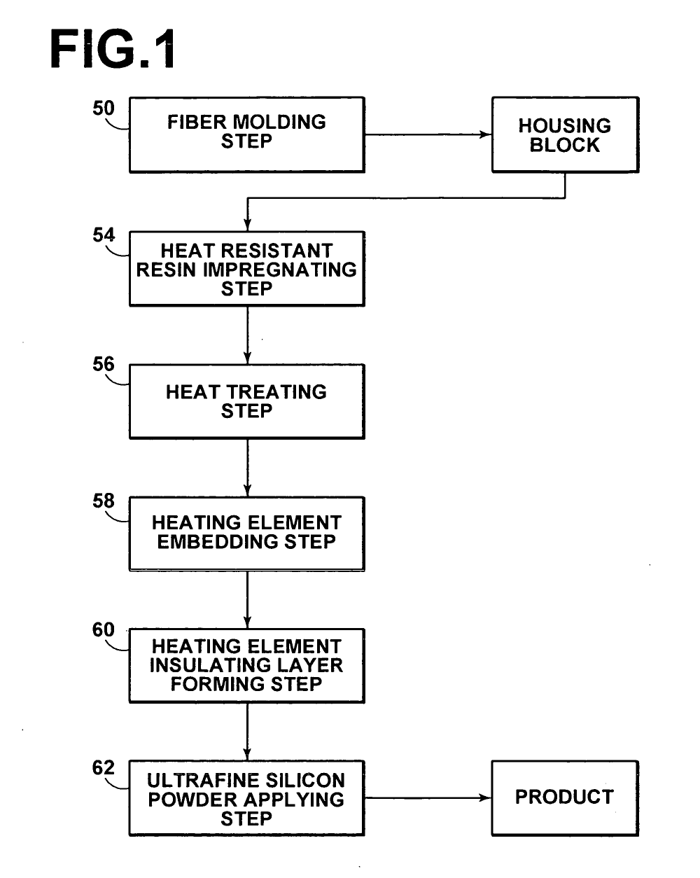

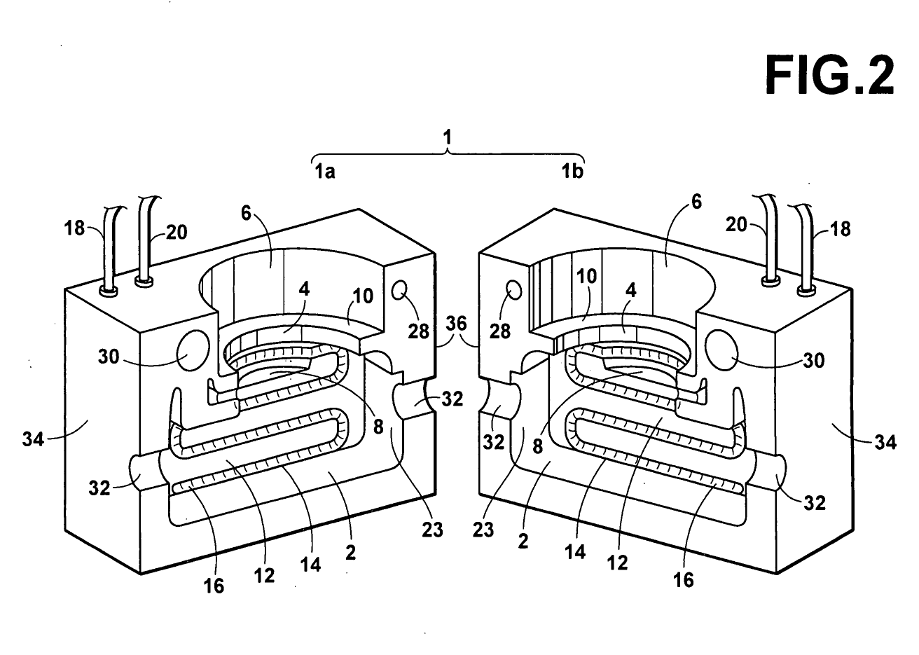

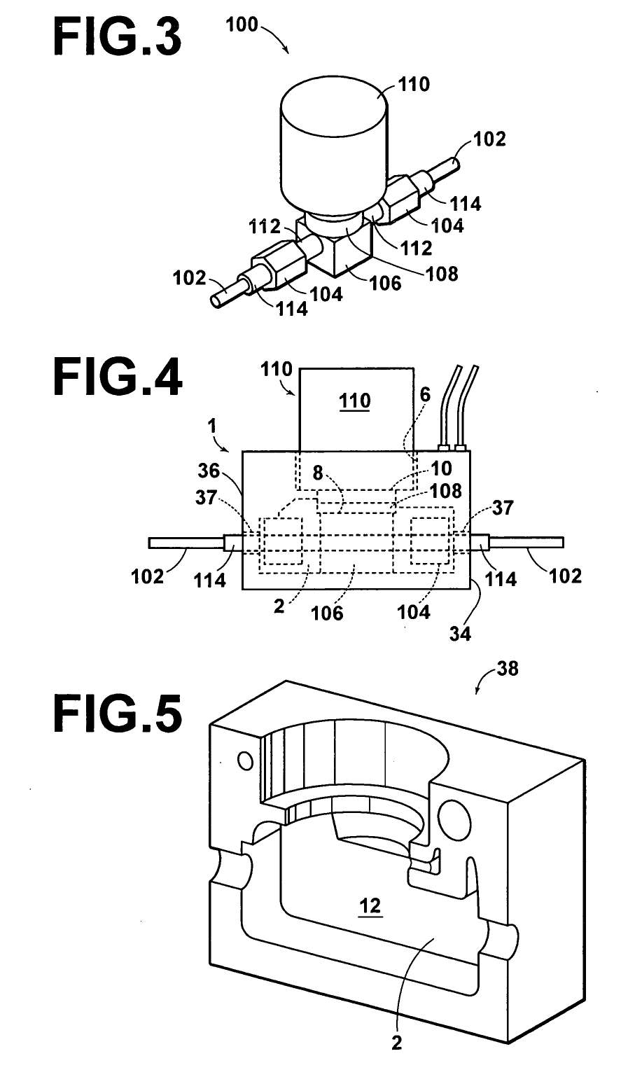

Hereinafter preferred embodiments of the heater unit manufacturing method (hereinafter, simply referred to as “manufacturing method”) according to the present invention will be described in detail with reference to the accompanying drawings. FIG. 1 is a flowchart illustrating the respective steps of the manufacturing method of the present invention. FIG. 2 is an exploded perspective view of an illustrative heater unit manufactured by the manufacturing method of the present invention. FIG. 3 is a perspective view of a valve which is an illustrative heating object of the heater unit shown in FIG. 2. FIG. 4 is a drawing illustrating the valve shown in FIG. 3 with the heater unit shown in FIG. 2 being mounted thereon.

First, an open/close valve 100 having comparatively complicated contour on which a heater unit 1 is to be mounted will be described with reference to FIG. 3. The entire valve is indicated by the reference numeral 100, which is connected to fluid pipes 102 through joints 104. The valve 100 comprises a cuboid body 106, a diaphragm case having a diaphragm mechanism 108 therein (not shown), a cylindrical actuator 110, and a pair of connecting sections 112. Each of the connecting sections 112 is connected to the pipe 102 through the hexagonal nut-shaped joint 104 and a sleeve 114. When the actuator 110 is operated, a fluid flows from one of the connecting sections 112 to the opposite connecting section 110 through the body 106, diaphragm case 108, again through the body 106. Thus, these sections are flow path forming sections of the valve 100. The flow path forming sections including the joints 104 need to be properly heated to avoid dew condensation and blockage described earlier. The structure of the valve 100 is well known in the art, and detailed description thereof will be omitted here.

Next, the heater unit 1 will be described with reference to FIG. 2. In FIG. 2, identical sections are given the same reference numerals. The heater unit 1 comprises a pair of housing halves 1a, 1b, each having a symmetrical structure with each other. When the housing halves 1a, 1b are fitted together, the heater unit 1 that covers the valve 100 is formed. Each of the housing halves 1a, 1b has a recessed portion 2 for receiving the body 106 of the valve 100. Each of the housing halves 1a, 1b also has a circular arc cutout 4 communicating with the recessed portion 2 for receiving the diaphragm case 108 having a circular contour, and a circular arc recessed portion 6 adjacent to the cutout 4 for receiving the actuator 110. As shown in FIG. 4, the heater unit 1 is formed such that the diaphragm case 108 of the valve 100 is seated on shoulders 8 located below the cutouts 4, and the actuator 110 is seated on floors 10 of the recessed portions 6 when it is mounted on the valve 100.

A meandered groove 14 is formed on the substantially entire surface of a side wall 12 of each of the recessed portions 2, and a heater (heating element) 16 is mounted along each of the grooves 14. The heaters 16 are connected to a lead wire 18 whose both ends are drawn outside, and generate heat when a current is flowed through the lead wire 18. The heater 16 of each of the housing halves 1a, 1b is linked with each other through a lead wire 20. The linked state of the heaters 16 is not shown in the drawing. The heater unit 1 is structured such that each of the heaters 16 is placed adjacent to the body 106 and diaphragm case 108 on each side thereof and heats them directly when they are received by the recessed portions 2. The inner surface of each of the housing halves 1a, 1b other than the area where the heater 16 is disposed forms radiant heating section. The radiant heating section is not limited to the area around the heater 16, but also includes all of the areas where heat is transferred from the heater 16, such as an inner wall 23 of the recessed portion 2, the recessed portion 6, cutouts 32 to be described later, and the like. Accordingly, the valve 100 is also heated by these radiant heating sections.

The housing halves 1a, 1b have screw cramp holes 28, 30 to fit them together and integrate as the heater unit 1. But, the integration method is not limited to the screw cramp. The housing halves 1a, 1b may be fixed together by any means, including the use of fixing band or latch engagement.

The semicircular cutouts 32 on the opposite walls 34, 36 formed in communication with the recessed portion 2 in one of the housing halves 1a, 1b create circular through-holes 37 (FIG. 4) with the corresponding cutouts 32 in other housing half when the housing halves 1a, 1b are fitted together. As shown in FIG. 4, sleeves 114 are placed through the through-holes 37. As the FIG. 4 illustrates well, the lower portion of the actuator 110 of the valve 100, diaphragm case 108, joints 104, and part of sleeves 114 are covered by the housing halves 1a, 1b in closed contact when the heater unit 1 is mounted on the valve 100. This allows the extended area of the valve 100, including the connecting sections 112 and joints 104, to be heated and maintained at a predetermined temperature. A thermocouple, which is a temperature sensor, is omitted in the drawing.

Hereinafter, a method for manufacturing the heater unit 1 having the configuration described above will be described with reference to FIG. 1. Ceramic fibers are used as the material for manufacturing the heater unit 1. The ceramic fibers used herein are short length fibers (registered brand name: Isowool) produced by melting a high purity alumina material through an electrical melting process, and blowing it by high speed airflows, and have superior heat resistance property of not less than 1260 degrees Celsius and density. In addition to alumina, other elements, such as silica and the like may also be included as the components of the ceramic fibers, and the ratio of the components may be changed accordingly. The ceramic fibers used have a diameter of approximately 2.8 μm with the length of not greater than 250 mm. In the present embodiment, ceramic fibers having a length of a few millimeters are used. But, the fibers do not necessary have a uniform length, and the fibers shorter or longer than a few millimeters may be included as well. Depending on the size of the heater unit 1, ceramic fibers primarily constituted by the fibers having appropriate dimensions are used.

As the fiber molding step 50 indicates, the ceramic fibers are molded by a molding machine (not shown) into heat insulating housing blocks having predetermined configurations, that is, the configurations of the housing halves 1a and 1b. When molding the housing blocks, ceramic fibers are suspended in water and an inorganic or organic binder is added thereto to make it slurry as the ceramic fibers themselves are threads. Then the slurry is molded and dried to obtain the housing halves 1a and 1b. Any molding methods, including compression molding, may be used in the molding step 50. In addition, the molding may be performed manually depending on the method used.

One of the housing blocks corresponding to the housing half 1b is shown in FIG. 5. FIG. 5 is a perspective view of the housing block 38 for creating the housing half 1b of the heater unit 1. The housing block for creating the housing half 1a is omitted in the drawing, since the configuration thereof is substantially symmetrical to that of the heat insulating housing block 38 shown in FIG. 5. The heat insulating housing block 38 is substantially identical in configuration to the housing half 1b without the groove 14 (FIG. 1) for mounting the heater 16 on the side wall 12 of the recessed portion 2, which will be provided in the subsequent cutting step. Of course, the groove 14 may be provided through the molding of the housing block 38 simultaneously, instead of the cutting step. In FIG. 1, the left column indicates each of the manufacturing steps, and the right column indicates each of the items produced by the corresponding step.

Next, the heat insulating housing block 38 is impregnated with heat resistant resin at the heat resistant resin impregnating step 54. The heat resistant resin used here is organic silicon carbide series paint (trade name: Tyranocoat). The paint is high heat resistant ceramics paint that includes organic silicon polymer (tyranopolymer), which is the precursor of the silicon carbide continuous fibers (trade name: Tyranofiber), as the primary binder, and may withstand the temperatures over 800 degrees Celsius. The organic silicon carbide series paint (trade name: Tyranocoat) comes in variety including basic transparent varnish, colored varnish which is the mixture of the transparent varnish and a pigment, and either of them may be used.

The organic silicon polymer, which is the binder of the organic silicon carbide series paint, is a thermoplastic plastic having a melting point of approximately 220 degrees Celsius. It has a mesh-shaped structure in which the principal chains of carbosilane skeleton are cross-linked by organic titanium compound. It initiates mineralization at 400 degrees Celsius and completes it at 700 degrees Celsius, and maintains stable amorphous ceramics state without loss on heat until over 120 degrees Celsius. Then, the organic silicon polymer is transformed into amorphous ceramics composed of silicon, carbon, titanium and oxygen after mineralization.

The impregnating step is performed by an appropriate method selected from the group of brushing, dipping and spraying, depending on the configuration, size, and quantities of the object to be produced, that is, the heat insulating housing block 38, and the like. In the present embodiment, the impregnating step is performed by brushing. When the heat resistant resin described above is applied on the heat insulating housing block 38 by brushing, it spreads from the surface of the heat insulating housing block 38 into the inside thereof. The reason for this is that the heat insulating housing block 38 is made of multitudes of fibers which are integrally molded together, and the heat resistant resin may spread between these fibers. The extent of the spreading is dependent on the amount of paint applied on the heat insulating housing block 38 and application time, but it may spread into the inside as far as approximately 2 mm from the surface thereof. Here, it should be noted that the inner side deeper than 2 mm from the surface comprises a heat insulating layer formed by the multitudes of fibers with air contained therein. This allows the heat generated by the heater 16 to be contained therein and effectively used for heating, as well as providing good heat retaining effect.

Thereafter, the heat insulating housing block 38 is left at room temperature and dried to the touch, i.e., dried until the paint does not stick to the finger tip when touched.

Then, the dried heat insulating housing block 38 is heat treated as the heat treating step indicates. In the heat treating step 56, a first heat treating step is performed first at a temperature in the range from 200 to 300 degrees Celsius, which is a preliminary heat treatment to eliminate the low temperature binder performed prior to the subsequent second heat treatment. Then, the second heat treating step is performed for approximately 30 minutes at a temperature in the range from 350 to 500 degrees Celsius. The second heat treating step ceramitizes the impregnated material and strengthens the impregnated layer on the surface of the bulk of ceramic fibers. The thickness of the surface reinforcing layer is in the range from approximately 0.5 mm to approximately 2 mm. This prevents fibers from peeling off the surface of the heat insulating housing block 38, thereby dust emissions are prevented. Here, the heat insulating layer inside of the heat insulating housing block 38 is maintained, so that the heat insulation capability is not lost by the heat treatment.

The heat insulating housing block 38 with reinforced impregnated layer on the surface has an irregular surface. The reason for this is that the bulk made of ceramic fibers molded integrally is the base material of the heat insulating housing block 38. But cutting operation may be performed on the heat insulating housing block 38, since it has a reinforced surface. For example, the surface and other required portions of the heat insulating housing block 38 may be smoothed.

Next, the manufacturing process moves to a heating element embedding step 58. In the step, the heater 16, such as a nichrome wire or the like, is mounted in the groove 14 of the heat insulating housing block 38.

Then, in a heating element insulating layer forming step 60, a high heat resistant surface hardening agent having a high viscosity, or the like is applied and solidified to fix the heater 16 in the groove 14, and to form an electrical insulating layer. This prevents an electrical contact between the heater 16 and heating objects, thereby short circuiting is prevented. The high heat resistant surface hardening agent may be heat resistant paint with ultrafine silicon powders mixed therein and having a predetermined viscosity, which will be described herein below.

Then, in an ultrafine silicon powder applying step 62, which is the final step of the manufacturing process, heat resistant paint with ultrafine silicon powders mixed therein and having a predetermined viscosity is applied on the surface and dried. Further, the surface is ground to obtain a smooth surface finish. The surface finish using the heat resistant paint may be performed a plurality of times.

This concludes the manufacturing process and the housing halves 1a and 1b comprising the heater unit 1 are produced. The heater unit 1 constituted by the housing halves 1a and 1b is light weighted and has high heat insulating and resisting properties. From the aspect of heat resisting property, the heater unit 1 may heat and retain the heating object at a considerably higher temperature. For example, in the present embodiment, the valve 100 may be heated and retained at 350 degrees Celsius.

While the present invention has be described in detail by way of a preferred embodiment, it should be appreciated that the present invention is not limited to the aforementioned embodiment, and modifications and variations will be apparent to those skilled in the art.

For example, the housing block 38 may be molded to have a configuration which is almost identical to that of the housing half 1a or 1b in the molding step 50, and cutting step may be performed additionally as described above. Preferably, however, the depth of a cut provided by the cutting step to be performed after the heat resistant resin impregnating step 54 is shallower than the impregnated layer.

1. A heater unit manufacturing method, comprising the steps of:
forming multitudes of inorganic fibers into a heat insulating housing block according to the contour of a heating object;
heat treating the heat insulating housing block after impregnating the block with heat resistant resin; and
mounting a heating element inside of the heat treated heat insulating housing block.

2. The heater unit manufacturing method according to claim 1, wherein the heat resistant resin is organic silicon carbide series paint.

3. The heater unit manufacturing method according to claim 1, wherein the heat treating step comprises the steps of:
a first heat treating step in which the housing block is preliminarily heated at a temperature in the range from 200 to 300 degrees Celsius; and
a second heat treating step in which the housing block is ultimately heated at a temperature in the range from 350 to 500 degrees Celsius.

4. The heater unit manufacturing method according to claim 2, wherein the heat treating step comprises the steps of:
a first heat treating step in which the housing block is preliminarily heated at a temperature in the range from 200 to 300 degrees Celsius; and
a second heat treating step in which the housing block is ultimately heated at a temperature in the range from 350 to 500 degrees Celsius.

5. The heater unit manufacturing method according to claim 3, wherein the first heat treating step is performed at a temperature in the range from 240 to 260 degrees Celsius, and the second heat treating step is performed at a temperature in the range from 440 to 480 degrees Celsius.

6. The heater unit manufacturing method according to claim 4, wherein the first heat treating step is performed at a temperature in the range from 240 to 260 degrees Celsius, and the second heat treating step is performed at a temperature in the range from 440 to 480 degrees Celsius.

7. The heater unit manufacturing method according to claim 1, further comprising the step of applying heat resistant paint with fine silicon powders mixed therein on the external surface of the heat insulating housing block after the heating element is mounted therein.

8. The heater unit manufacturing method according to claim 2, further comprising the step of applying heat resistant paint with fine silicon powders mixed therein on the external surface of the heat insulating housing block after the heating element is mounted therein.

9. The heater unit manufacturing method according to claim 3, further comprising the step of applying heat resistant paint with fine silicon powders mixed therein on the external surface of the heat insulating housing block after the heating element is mounted therein.

10. The heater unit manufacturing method according to claim 4, further comprising the step of applying heat resistant paint with fine silicon powders mixed therein on the external surface of the heat insulating housing block after the heating element is mounted therein.

11. The heater unit manufacturing method according to claim 5, further comprising the step of applying heat resistant paint with fine silicon powders mixed therein on the external surface of the heat insulating housing block after the heating element is mounted therein.

12. The heater unit manufacturing method according to claim 6, further comprising the step of applying heat resistant paint with fine silicon powders mixed therein on the external surface of the heat insulating housing block after the heating element is mounted therein.
